(19) United States
(12) Patent Application Publication
(10) Pub. No.: US 2008/0241391 A1
(43) Pub. Date: Oct. 2, 2008

(54) METHOD OF MANUFACTURING A METAL NANOPARTICLE, CONDUCTIVE INK COMPOSITION HAVING THE METAL NANOPARTICLE AND METHOD OF FORMING A CONDUCTIVE PATTERN USING THE SAME

(76) Inventors: JANG SUB KIM, Suwon-si (KR); Soon-Kwon Lim, Yongin-si (KR); Joo-Ho Moon, Seoul (KR); Sun-Ho Jeong, Seoul (KR); Dong-Jo Kim, Yongin-si (KR); Kyoo-Hee Woo, Seoul (KR)

Correspondence Address: F. CHAU & ASSOCIATES, LLC, 130 WOODBURY ROAD, WOODBURY, NY, 11797, US

(21) Appl. No.: 12/021,050

(22) Filed: Jan. 28, 2008

(30) Foreign Application Priority Data
Mar. 30, 2007 (KR) 2007-31300

(51) Int. Cl. B05D 5/12; C09D 11/10; H01B 1/00

(52) U.S. Cl. 427/256; 525/326.9; 252/519.2

(57) ABSTRACT

A method of manufacturing a metal nanoparticle includes coupling a metal ion to an organic ligand having a weight-average molecular weight of about 10,000 to about 1,500,000. The method further includes reducing the metal ion coupled to the organic ligand to form a metal nanoparticle having a skin layer.

### CROSS-REFERENCE TO RELATED APPLICATIONS

This application claims priority under 35 USC § 119 to Korean Patent Application No. 2007-31300, filed on Mar. 30, 2007, the disclosure of which is hereby incorporated by reference herein in its entirety.

### BACKGROUND OF THE INVENTION

1. Technical Field

The present disclosure relates to a method of manufacturing a metal nanoparticle, a conductive ink composition having the metal nanoparticle, and a method of forming a conductive pattern using the conductive ink composition. More particularly, the present disclosure relates to a method of manufacturing a metal nanoparticle, which is capable of reducing manufacturing costs of a conductive pattern and increasing oxidation stability, a conductive ink composition having the metal nanoparticle and a method of forming a conductive pattern using the conductive ink composition.

2. Description of the Related Art

Generally, an optical patterning method using photolithography is used for forming a conductive pattern. However, the optical patterning method using photolithography may include many processing steps and be complicated, such that the manufacturing costs of the conductive pattern may be increased. Furthermore, types of substrates which may be used in the optical patterning method may be limited due to an exposure process and a development process. Furthermore, environmental pollution may be caused by gas and wastewater generated in the exposure process and the development process. In order to solve the above-mentioned difficulties, active research has been conducted on low-cost and environment-friendly patterning methods, such as for example, an inkjet printing method, a gravure printing method, a screen printing method, a spin-coating method, a drop-casting method, a dip-coating method, etc.

For example, a method using a conductive polymer has been developed to form a conductive pattern. Poly(ethylenedioxythiophene) doped with poly(styrene sulfonic acid) (PEDOT/PSS), which is a conductive polymer of H. C. Starck (Germany), has a relatively high conductivity among conductive polymers and relatively high stability in air. However, the conductivity of the PEDOT/PSS is about 0.1 S/cm that is much less than the conductivity of a metal, which is about 10⁵ to about 10⁶ S/cm. Thus, active research has been conducted on an ink containing metal nanoparticles capable of having a relatively high conductivity through a heating process at a relatively low temperature.

Examples of the metal nanoparticles may include but are not limited to nanoparticles of gold, silver, platinum, copper, nickel, iron, cobalt, zinc, chromium, manganese, etc. Manufacturing costs of the nanoparticles of copper, nickel, iron, cobalt, zinc, chromium and manganese are relatively low compared to precious metals such as gold, silver and platinum. However, the nanoparticles of copper, nickel, iron, cobalt, zinc, chromium and manganese have relatively low oxidation stability.

### SUMMARY OF THE INVENTION

Exemplary embodiments of the present invention provide a method of manufacturing a metal nanoparticle, which is capable of reducing manufacturing costs of a conductive pattern and increasing oxidation stability.

Exemplary embodiments of the present invention also provide a conductive ink composition having the above-mentioned metal nanoparticle.

Exemplary embodiments of the present invention also provide a method of forming a conductive pattern using the above-mentioned conductive ink composition.

In accordance with an exemplary embodiment of the present invention, a method of manufacturing a metal nanoparticle is provided. The method includes coupling a metal ion to an organic ligand, having a weight-average molecular weight of about 10,000 to about 1,500,000, and reducing the metal ion coupled to the organic ligand to form a metal nanoparticle having a skin layer.

For example, a weight-average molecular weight of the organic ligand may be about 40,000 to about 360,000, and the organic ligand may include polyvinyl pyrrolidone.

For example, the metal ion may be coupled to the organic ligand in a solvent including glycol, alcohol, etc.

Examples of the metal ion may include but are not limited to a copper ion, a nickel ion, an iron ion, a cobalt ion, a zinc ion, a chromium ion, a manganese ion, etc. A diameter of the metal nanoparticle may be about 1 to about 100 nanometer (nm).

In accordance with an exemplary embodiment of the present invention, a conductive ink composition is provided. The conductive ink composition includes about 15 to about 50 parts by weight of metal nanoparticles and about 50 to about 80 parts by weight of a solvent. The metal nanoparticles are coupled to a capping polymer having a weight-average molecular weight of about 10,000 to about 1,500,000.

The capping polymer may form a skin layer surrounding the metal nanoparticles. For example, a weight-average molecular weight of the capping polymer may be about 40,000 to about 360,000, and the capping polymer may include polyvinyl pyrrolidone.

For example, examples of the solvent may include but are not limited to ketone, alcohol, glycol, etc. The conductive ink composition may further include about 0.01 to about 5 parts by weight of a dispersion agent and/or about 1 to about 20 parts by weight of a wetting agent.

Examples of the metal nanoparticles may include but are not limited to copper, nickel, iron, cobalt, zinc, chromium, manganese, etc.

In accordance with an exemplary embodiment of the present invention, a method of forming a conductive pattern is provided. The method includes coating a conductive ink composition on a substrate and heating the conductive ink composition to form a conductive pattern. The conductive ink composition includes a solvent and metal nanoparticles coupled to a capping polymer having a weight-average molecular weight of about 10,000 to about 1,500,000.

For example, a weight-average molecular weight of the capping polymer may be about 40,000 to about 360,000, and the capping polymer may include polyvinyl pyrrolidone.

For example, the conductive ink composition may be heated at about 100 to about 400° C. Furthermore, the conductive ink composition may be heated in a vacuum, in a reduction atmosphere, or in an atmosphere including an inactive gas.

According to the above-mentioned exemplary embodiments of the present invention, the oxidation stability of a metal nanoparticle may be improved. Thus, the conductivity of a conductive pattern formed from the metal nanoparticle may be increased.

### BRIEF DESCRIPTION OF THE DRAWINGS

Exemplary embodiments of the present invention can be understood in more detail from the following description when considered in conjunction with the accompanying drawings wherein:

FIG. 1 is a flow chart explaining a method of manufacturing a metal nanoparticle according to an exemplary embodiment of the present invention;

FIG. 2 is a flow chart explaining a method of forming a conductive pattern according to an exemplary embodiment of the present invention;

FIGS. 3, 4 and 5 are graphs respectively illustrating X-ray photoelectron spectroscopy (XPS) data of the copper nanoparticles of Examples 1, 2 and 3;

FIG. 6 is a graph showing XPS data of the copper nanoparticles of Example 2;

FIGS. 7, 8 and 9 are transmission electron microscopy (TEM) pictures respectively showing the copper nanoparticles of Example 1, 2 and 3;

FIG. 10 is a graph showing conductivities of the conductive patterns of Example 4 to 6, which vary depending on a heating temperature; and

FIG. 11 is a graph showing far infrared spectroscope data of the conductive pattern of Example 5.

### DETAILED DESCRIPTION OF THE EXEMPLARY EMBODIMENTS OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

### Method of Manufacturing a Metal Nanoparticle

FIG. 1 is a flow chart explaining a method of manufacturing a metal nanoparticle according to an exemplary embodiment of the present invention. Referring to FIG. 1, a metal ion is coupled to an organic ligand, of which a weight-average molecular weight is about 10,000 to about 1,500,000, in a solvent (step S10). The metal ion coupled to the organic ligand is reduced to form a metal nanoparticle having a skin layer (step S20).

For example, a metal salt may be dissolved in a predetermined solvent to prepare the metal ion. Examples of the metal ion may include but are not limited to a metal ion capable of forming a metal nanoparticle through reduction, such as a copper ion, a nickel ion, an iron ion, a cobalt ion, a zinc ion, a chromium ion, a manganese ion, etc. Manufacturing costs of the above-mentioned ions are relatively low compared to ions of precious metals such as gold, platinum, etc.

Examples of the metal salt may include but are not limited to copper sulfate hydrate, copper chloride hydrate, copper nitrate, silver nitrate, cobalt chloride, nickel perchlorate, etc. Examples of the solvent may include an alcohol, a glycol such as diethylene glycol, etc.

Examples of the organic ligand may include but are not limited to a chain-shaped polymer capable of forming a coordinate covalent bond with a metal ion, such as polyvinyl pyrrolidone, polypyridine, polylactone, etc. Hereinafter, polyvinyl pyrrolidone will be explained as an example of the organic ligand.

Polyvinyl pyrrolidone may be represented by the following Chemical Formula 1.

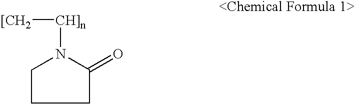

In the above formula 1, n denotes a natural number.

Polyvinyl pyrrolidone may be coupled to a metal ion and may form a coordinate covalent bond as illustrated by the following Reaction Equation 1.

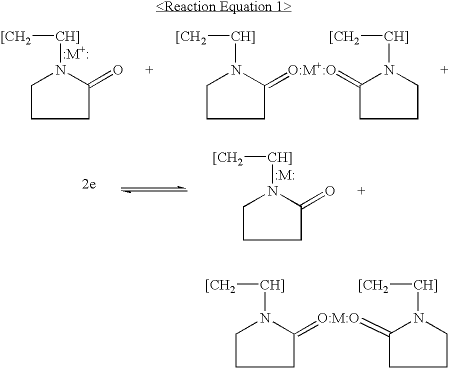

Referring to Reaction Equation 1, one metal ion may be coupled to an unshared electron pair of a nitrogen atom and an unshared electron pair of an oxygen atom, of one polyvinyl pyrrolidone. Alternatively, one metal ion may be coupled to an unshared electron pair of an oxygen atom of each of two polyvinyl pyrrolidone molecules. Furthermore, the metal ion may be coupled with polyvinyl pyrrolidone to form a coordinate covalent bond in theoretically possible ways similar to the above.

When the metal ions coupled to polyvinyl pyrrolidone are provided with a reduction agent or heated, the metal ions are reduced to form a metal nanoparticle. When the metal ions are reduced, the polyvinyl pyrrolidone may form a skin layer of the metal nanoparticle. In the course of reduction of the metal ions, a portion of polyvinyl pyrrolidone molecules coupled to the metal ions may be decomposed.

The skin layer may prevent the metal nanoparticle from making contact with oxygen. Thus, oxidation of the metal nanoparticle may be prevented and/or reduced. The anti-oxidation ability of the skin layer may depend on a structure of the skin layer and molecular weight of the polyvinyl pyrrolidone. For example, a mole ratio of the metal ion to the polyvinyl pyrrolidone in the solvent may be about 0.1:1 to about 6:1.

As polyvinyl pyrrolidone has a chain shape and a relatively high molecular weight, polyvinyl pyrrolidone coupled to the metal nanoparticle may have an orientation substantially perpendicular to a surface of the metal nanoparticle. Thus, the skin layer may be relatively thick and may be formed closely. Therefore, the skim layer may prevent oxygen gas from diffusing into a core of the metal nanoparticle to improve oxidation stability of the metal nanoparticle.

The polyvinyl pyrrolidone coupled to the metal nanoparticle may allow the metal nanoparticle to be easily dispersed. For example, a tail portion of the polyvinyl pyrrolidone, which is not directly coupled to the metal nanoparticle, may extend toward a direction opposite to the core of the metal nanoparticle. Thus, the metal nanoparticle may have steric dispersion characteristics in the solvent and may be stably dispersed.

A reduction agent may be used in order to reduce the metal ion. Examples of the reduction agent may include but are not limited to sodium phosphinate hydrate, hydrazine, sodium borohydride, lithium aluminum hydride, etc. These can be used alone or in a combination thereof.

A diameter of the metal nanoparticle may be about 1 to about 100 nm, and for example about 1 to about 50 nm.

According to an exemplary embodiment of the present invention, oxidation of a metal nanoparticle may be increased so that a metal oxide in the metal nanoparticle is reduced. Thus, the melting temperature of the metal nanoparticle may be reduced, and the conductivity of a conductive pattern formed from the metal nanoparticle may be increased. Furthermore, manufacturing costs of a conductive pattern may be reduced.

For example, the weight-average molecular weight of the organic ligand may be about 40,000 to about 360,000. When the weight-average molecular weight of the organic ligand is more than about 40,000, a proportion of a metal oxide in a metal nanoparticle may be significantly reduced. However, when the weight-average molecular weight of the organic ligand is more than about 360,000, the thickness of a skin layer of the metal nanoparticle may be significantly increased so that a remaining polymer reduces the conductivity of a conductive pattern.

Hereinafter, a conductive ink composition according to an exemplary embodiment of the present invention will be described in further detail.

Conductive Ink Composition

A conductive ink composition according to an exemplary embodiment of the present invention includes about 15 to about 50 parts by weight of metal nanoparticles and about 50 to about 80 parts by weight of a solvent. The metal nanoparticle is coupled to a capping polymer, of which a weight average molecular weight is about 10,000 to about 1,500,000.

The conductive ink composition may further include a dispersion agent and/or a wetting agent. The content of the dispersion agent may be about 0.01 to about 5 parts by weight. The content of the dispersion agent may be about 1 to about 20 parts by weight.

Examples of the metal nanoparticle may include but are not limited to copper, nickel, iron, cobalt, zinc, chromium, manganese, etc. The metal nanoparticle may be formed by reducing a metal ion coupled to an organic ligand.

The metal nanoparticle may have a core and a skin layer surrounding the core. For example, the capping polymer may form the skin layer surrounding the core, and a metal oxide may be mixed with the capping polymer in the skin layer. The organic ligand may serve as the capping polymer after the metal ion is reduced. The skin layer may prevent the metal nanoparticle from making contact with oxygen to prevent and/or reduce a metal oxide formed from the metal nanoparticle.

Examples of the capping polymer may include but are not limited to polyvinyl pyrrolidone, polypyridine, polylactone, etc.

The metal nanoparticle is substantially the same as the above-explained metal nanoparticle manufactured by a method of manufacturing a metal nanoparticle according to an exemplary embodiment of the present invention. Thus, any further explanation will be omitted.

When the content of the solvent is less than about 50 parts by weight, the viscosity of the conductive ink composition may be significantly increased so that the conductive ink composition may not be stably sprayed. When the content of the solvent is more than about 80 parts by weight, the conductivity of the conductive pattern may be reduced as the density of a conductive pattern formed from the conductive ink composition is reduced. For example, examples of the solvent may include but are not limited to ketone, alcohol, glycol, etc. These can be used alone or in a combination thereof.

For example, the solvent may include a non-aqueous solvent mixture. For example, the non-aqueous solvent mixture may include a first solvent, of which a viscosity is about 0.1 to about 5 mPa·s at about 25° C., a second solvent, of which a viscosity is about 15 to about 40 mPa·s at about 25° C., and a third solvent, of which a vapor pressure is about 10 to about 250 mmHg at about 25° C.

For example, the non-aqueous solvent mixture may include about 30 to about 60% by weight of the first solvent, about 30 to about 60% by weight of the second solvent and about 10 to about 30% by weight of the third solvent, based on a total weight of the non-aqueous solvent mixture. When the conductive ink composition includes the non-aqueous solvent mixture, oxidation stability of the metal nanoparticle may be improved since the conductive ink composition does not include water.

Examples of the first solvent may include but are not limited to 4-methoxy ethanol, propyl alcohol, pentyl alcohol, hexyl alcohol, butyl alcohol, octyl alcohol, formamide, methyl ethyl ketone, etc. These can be used alone or in a combination thereof.

Examples of the second solvent may include but are not limited to ethylene glycol, diethylene glycol, triethylene glycol, polyethylene glycol, propylene glycol, dipropylene glycol, hexylene glycol, glycerin, etc. These can be used alone or in a combination thereof.

Examples of the third solvent may include but are not limited to ethyl alcohol, methyl alcohol, isopropyl alcohol, acetone, etc. These can be used alone or in a combination thereof.

The dispersion agent may allow the copper nanoparticles to be readily dispersed in the ink composition. Examples of the dispersion agent may include but are not limited to conventional dispersion agents. For example, examples of the dispersion agent may include but are not limited to the 4000 series (trade name manufactured by EFKA in Netherlands), the Disperbyk series (trade name manufactured by BYK in Germany), the Solsperse series (trade name manufactured by Avecia in U.K.), the TEGO Disperse series (trade name manufactured by Degussa in Germany), the Disperse-AYD series (trade name manufactured by Elementis in U.S.A.), the JONCRYL series (trade name manufactured by Johnson Polymer in U.S.A.), etc. These can be used alone or in a combination thereof.

When the content of the dispersion agent is less than about 0.01 parts by weight, the copper nanoparticles may form a clump. When the content of the dispersion agent is more than about 5 parts by weight, dispersion agent molecules may cohere with each other so that dispersion ability of the dispersion agent is reduced.

The wetting agent maintains the humidity of the ink composition to prevent clogging of the ink composition at an interface of the nozzle of the printer. Examples of the wetting agent may include but are not limited to conventional wetting agents. For example, the dispersion agent may include but is not limited to polyethylene glycol, the Surfynol series (trade name manufactured by Air Product in U.S.A.), the TEGO wet series (trade name manufactured by Degussa in Germany), etc. These can be used alone or in a combination thereof.

The conductive ink composition may be coated on a substrate by, for example, an inkjet printing method, a gravure printing method, a screen printing method, etc.

For example, when the conductive ink composition is sprayed by an inkjet printer, the conductive ink composition may have a predetermined viscosity and a predetermined surface tension suitable for a inkjet printing method. For example, when the conductive ink composition is sprayed by a piezoelectric inkjet printer, the viscosity of the ink composition may be about 0.5 to about 40 mPa·s at about 25° C., and the surface tension of the ink composition may be about 20 to about 70 mN/m at about 25° C.

When the conductive ink composition is sprayed by the inkjet printer, a high shear stress is applied to the ink composition adjacent to the nozzle of the inkjet printer. Thus, the ink composition may perform according to the Newtonian Flow so as to prevent the viscosity of the ink composition from significantly increasing.

A conductive ink composition according to an exemplary embodiment of the present invention includes metal nanoparticles coupled to a capping polymer. Thus, the oxidation stability of metal nanoparticles may be improved. Consequently, the conductivity of the conductive pattern formed from the conductive ink composition may be improved as well.

Method of Forming a Conductive Pattern

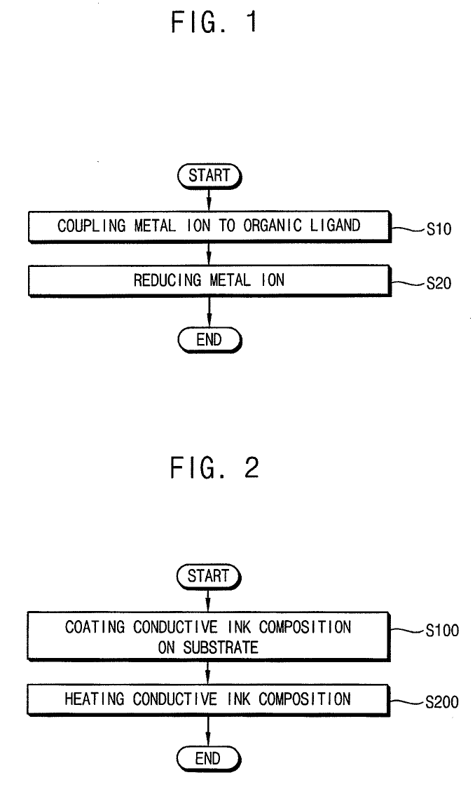

FIG. 2 is a flow chart explaining a method of forming a conductive pattern according to an exemplary embodiment of the present invention. Referring to FIG. 2, a conductive ink composition is coated on a substrate (step S100). The conductive ink composition on the substrate is heated to form a conductive pattern (step S200). The conductive ink composition includes a solvent and metal nanoparticles coupled to a capping polymer, of which a weight-average molecular weight is about 10,000 to about 1,500,000.

The conductive ink composition may further include a dispersion agent and/or a wetting agent. For example, the conductive ink composition may include about 15 to about 50 parts by weight of the copper nanoparticles, about 50 to about 80 parts by weight of the solvent, about 0.01 to about 5 parts by weight of the dispersion agent and about 1 to about 20 parts by weight of the wetting agent.

For example, the solvent may include a non-aqueous solvent mixture. For example, the non-aqueous solvent mixture may include a first solvent, of which a viscosity is about 0.1 to about 5 mPa·s at about 25° C., a second solvent, of which a viscosity is about 15 to about 40 mPa·s at about 25° C., and a third solvent, of which a vapor pressure is about 10 to about 250 mmHg at about 25° C.

For example, the non-aqueous solvent mixture may include about 30 to about 60% by weight of the first solvent, about 30 to about 60% by weight of the second solvent and about 10 to about 30% by weight of the third solvent, based on a total weight of the non-aqueous solvent mixture. When the conductive ink composition includes the non-aqueous solvent mixture, oxidation stability of the metal nanoparticle may be improved as the conductive ink composition does not include water.

The conductive ink composition is substantially the same as the above-explained conductive ink composition according to an exemplary embodiment of the present invention. Thus, any further explanation will be omitted.

Various substrates may be used as the substrate. For example, a metal substrate, a glass substrate, a silicon wafer, a polyester film, a polyimide film, etc. may be used as the substrate.

The conductive ink composition may be coated on a substrate by, for example, an inkjet printing method, a gravure printing method, a screen printing method, etc. For example, the conductive ink composition may be by an inkjet printer. A spraying method of the inkjet printer may include, for example, a continuous jet method and a drop-on-demand method. The continuous jet method continuously sprays ink using a pump, and controls a spraying direction by varying an electromagnetic field. The drop-on-demand method sprays ink at the desired time using an electric signal.

The drop-on-demand method may include, for example, a piezoelectric method using a piezoelectric plate physically deformed by an electricity to generate a pressure, and a thermal transcription method using a pressure due to a bubble expanded by heat.

After the conductive ink composition is coated onto the substrate, the conductive ink composition is heated. For example, the conductive ink composition is heated at a temperature of about 100 to about 400° C. When the conductive ink composition is heated, the solvent of the conductive ink composition is evaporated, and the metal nanoparticles are inseparably fused to form a conductive pattern. The capping polymer coupled to the metal nanoparticles may be decomposed by heat.

The metal nanoparticles may be melted at a temperature lower than the melting point of a metal bulk. For example, the melting point of copper bulk is about 1083° C. However, copper particles, of which the particle diameter is less than or equal to about 100 nm, have a surface area with respect to a volume, which is greater than that of the copper bulk. Thus, the copper particles have a high surface energy, and the copper particles may be fused below the melting point of the copper bulk as the copper particles may reduce the surface area thereof to be stabilized.

For example, the conductive ink composition may be heated in a vacuum, in a reduction atmosphere, or in an atmosphere including an inactive gas. When the conductive ink composition is heated in a vacuum or in a reduction atmosphere, or in an atmosphere including an inactive gas, oxidation of the conductive pattern formed from the conductive ink composition may be prevented and/or reduced so that the conductivity of the conductive pattern is increased. The reduction atmosphere may include, for example, a hydrogen gas. Examples of the inactive gas may include, for example, a nitrogen gas, an argon gas, a helium gas, etc.

A method of forming a conductive pattern according to an exemplary embodiment of the present invention may improve oxidation stability of metal nanoparticles. Thus, the conductivity of a conductive pattern may be increased.

A method of forming a conductive pattern according to an exemplary embodiment of the present invention may form a conductive pattern having a relatively high conductivity, and may be used in various fields such as, for example, a liquid crystal display apparatus, a plasma display panel, a electric tag, a circuit board, a sensor, etc.

Hereinafter, a method of manufacturing a metal nanoparticle, a conductive ink composition and a method of forming a conductive pattern, according to exemplary embodiments of the present invention will be described in further detail with reference to examples and experiments.

### Example 1

About 16 g of polyvinyl pyrrolidone, of which a weight-average molecular weight was about 10,000, about 220 mL of diethylene glycol were mixed and stirred at a normal temperature. The mixture was provided with about 1.8587 g of sodium phosphinate monohydrate serving as a reduction agent, and then stirred at a normal temperature to prepare a solvent mixture.

About 10.1617 g of copper sulfate pentahydrate and about 30 g of pure water were mixed and stirred at a normal temperature to dissolve the copper sulfate pentahydrate in the pure water, to thereby prepare a copper salt mixture.

After the solvent mixture had been heated to about 140° C., about 4 mL of the copper salt mixture per minute was provided to the solvent mixture using an injection pump. After maintaining a reaction of the solvent mixture and the copper salt mixture for about 1 hour, the obtained particles were separated from the mixture by a centrifugal separator. The particles are cleaned two times using methanol, and then dried in a vacuum oven to prepare copper nanoparticles.

### Example 2

Copper nanoparticles were prepared through substantially the same method as Example 1 except that about 16 g of polyvinyl pyrrolidone, of which a weight-average molecular weight is about 29,000, was used instead of about 16 g of polyvinyl pyrrolidone, of which a weight-average molecular weight was about 10,000.

### Example 3

Copper nanoparticles were prepared through substantially the same method as Example 1 except that about 16 g of polyvinyl pyrrolidone, of which a weight average molecular weight is about 40,000, was used instead of about 16 g of polyvinyl pyrrolidone, of which a weight-average molecular weight was about 10,000.

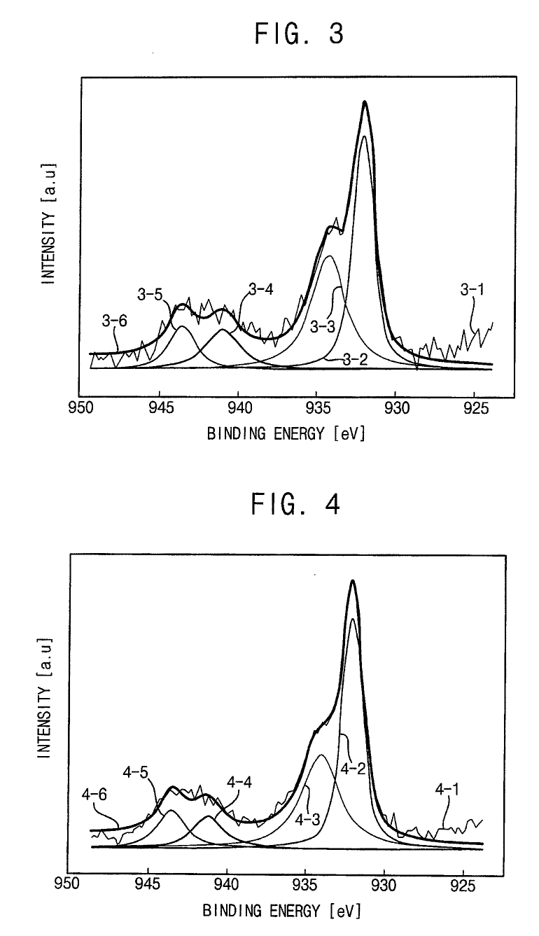

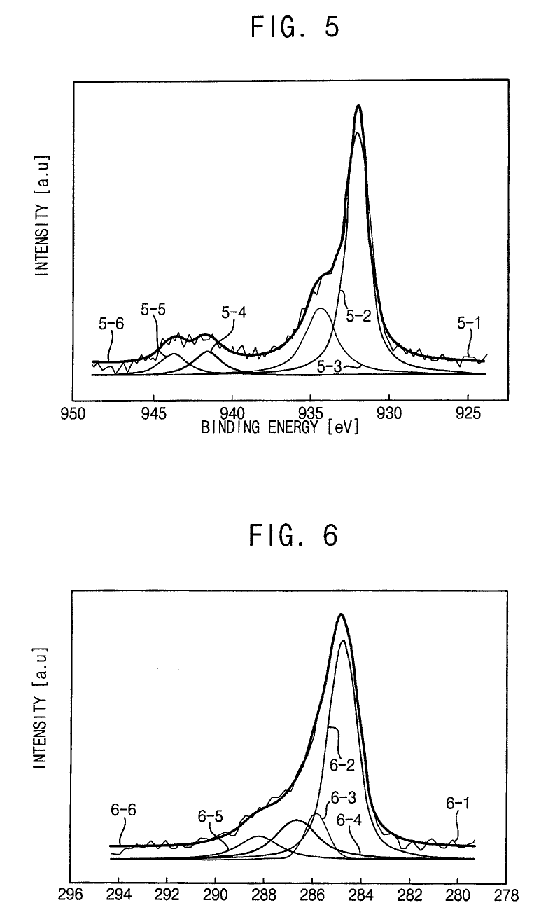

FIGS. 3, 4 and 5 are graphs respectively illustrating X-ray photoelectron spectroscopy (XPS) data of the copper nanoparticles of Examples 1, 2 and 3. Particularly, line 3-1, line 4-1 and line 5-1 respectively show raw data. Line 3-2, line 4-2 and line 5-2 respectively show peaks of a copper-copper bond. Line 3-3, line 4-3 and line 5-3 respectively show peaks of a copper-oxygen bond. Line 3-4, line 4-4 and line 5-4 are non-considered data respectively showing peaks of a copper-copper bond. Line 3-5, line 4-5 and line 5-5 respectively show non-considered data showing peaks of a copper-oxygen bond. Line 3-6, line 4-6 and line 5-6 respectively show summation data of each of the data.

Evaluating based on data of FIGS. 3 to 5, a proportion of a copper oxide in copper nanoparticles of Example 1 was about 0.47, a proportion of a copper oxide in copper nanoparticles of Example 2 was about 0.44 and a proportion of a copper oxide in copper nanoparticles of Example 3 was about 0.29. Thus, it can be noted that a proportion of a copper oxide in copper nanoparticles may be reduced as the molecular weight of polyvinyl pyrrolidone is increased. Furthermore, it can be noted that a proportion of a copper oxide in copper nanoparticles may be significantly reduced when the weight-average molecular weight of polyvinyl pyrrolidone is more than about 40,000.

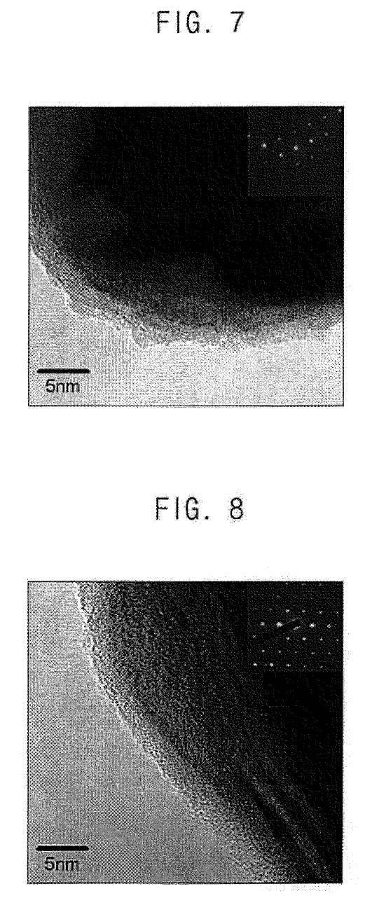

FIG. 6 is a graph showing XPS data of the copper nanoparticles of Example 2. For example, FIG. 6 shows XPS data showing bonds of copper atoms in the copper nanoparticles. Line 6-1 shows raw data. Line 6-2 shows peaks of a copper-hydrogen bond. Line 6-3 shows peaks of a copper-copper bond. Line 6-4 shows peaks of a copper-nitrogen bond. Line 6-5 shows peaks of a copper-oxygen bond. Line 6-6 shows summation data of each of the data. Referring to FIG. 6, it can be noted that the copper nanoparticles were coupled to polyvinyl pyrrolidone.

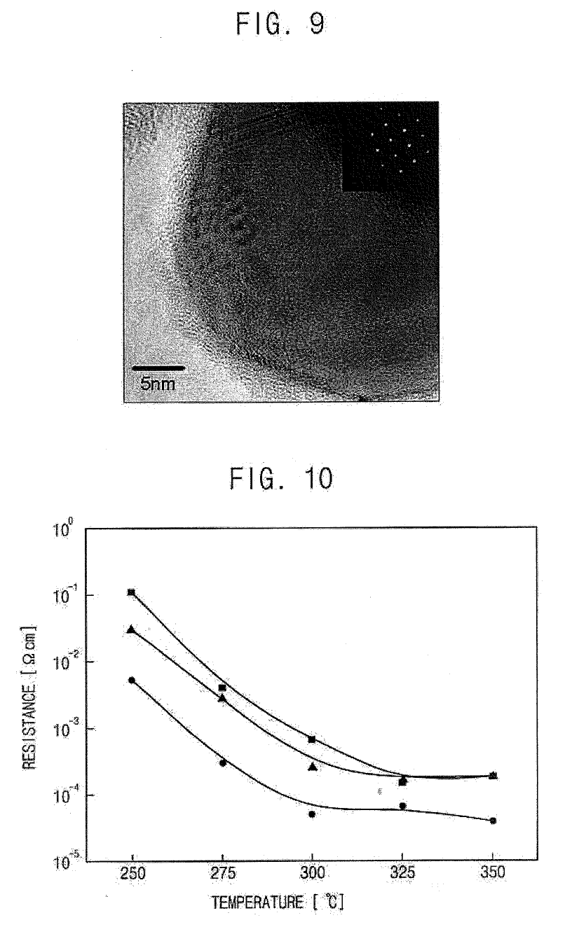

FIGS. 7, 8 and 9 are transmission electron microscopy (TEM) pictures respectively showing the copper nanoparticles of Example 1, 2 and 3. Referring to FIGS. 7 to 9, it can be noted that the copper nanoparticles of Example 1, 2 and 3 respectively have a core including crystalline copper and a skin layer including polyvinyl pyrrolidone and a copper oxide mixed with each other.

### Example 4

About 50 parts by weight of ethylene glycol, about 40 parts by weight of 4-methoxy ethanol and about 10 parts by weight of methanol were mixed with each other to prepare a non-aqueous solvent mixture. About 80 parts by weight of the non-aqueous solvent mixture and about 20 parts by weight of the copper nanoparticles of Example 1 were mixed with each other and then stirred through a ball milling method to prepare a conductive ink composition.

The conductive ink composition was sprayed onto a glass substrate by a printer to form a coated layer having a thickness of about 5 μm. The printer had a piezoelectric nozzle and was operated according to a drop-on-demand method. The coated layer was heated by gradually increasing the temperature from about 200 to about 350° C. to form a conductive pattern.

### Example 5

A conductive pattern was formed through substantially the same method as Example 4 except that the copper nanoparticles of Example 2 were used instead of the copper nanoparticles of Example 1.

### Example 6

A conductive pattern was formed through substantially the same method as Example 4 except that the copper nanoparticles of Example 3 were used instead of the copper nanoparticles of Example 1.

FIG. 10 is a graph showing conductivities of the conductive patterns of Example 4 to 6, which vary depending on a heating temperature. For example, a rectangular spot corresponds to the conductivity of the conductive pattern of Example 4. A triangular spot corresponds to the conductivity of the conductive pattern of Example 5. A circular spot corresponds to the conductivity of the conductive pattern of Example 6.

Referring to FIG. 10, it can be noted that the conductivities of the conductive patterns of Example 4 to 6 were reduced as the heating temperature was increased. Furthermore, it can be noted that the conductivity of the conductive pattern of Example 6 was much less than the conductivities of the conductive patterns of Examples 4 and 5.

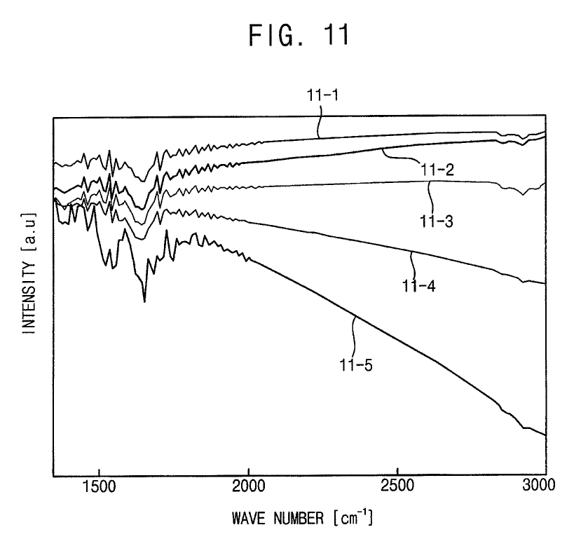

FIG. 11 is a graph showing far infrared spectroscopy data of the conductive pattern of Example 5. Particularly, line 11-1 shows data before heating. Line 11-2 shows data at about 225° C. Line 11-3 shows data at about 300° C. Line 11-4 shows data at about 325° C. Line 11-5 shows data at about 350° C. A peak corresponding to polyvinyl pyrrolidone is observed at a wave number of about 1,643 cm⁻¹.

Referring to FIG. 11, the peak corresponding to polyvinyl pyrrolidone at a wave number of about 1,643 cm⁻¹ was reduced as the heating temperature was increased. Thus, it can be noted that the polyvinyl pyrrolidone coupled to metal nanoparticles is decomposed through the heating process.

According to the above, oxidation of a metal nanoparticle may be improved. Thus, the conductivity of a conductive pattern formed from the metal nanoparticle may be increased.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A method of manufacturing a metal nanoparticle, the method comprising:
coupling a metal ion to an organic ligand having a weight-average molecular weight of about 10,000 to about 1,500,000; and
reducing the metal ion coupled to the organic ligand to form a metal nanoparticle having a skin layer.

2. The method of claim 1, wherein a weight-average molecular weight of the organic ligand is about 40,000 to about 360,000.

3. The method of claim 1, wherein the metal ion is coupled to the organic ligand in a solvent comprising at least one selected from the group consisting of glycol and alcohol.

4. The method of claim 1, wherein the organic ligand comprises polyvinyl pyrrolidone.

5. The method of claim 1, wherein the metal ion comprises at least one selected from the group consisting of a copper ion, a nickel ion, an iron ion, a cobalt ion, a zinc ion, a chromium ion and a manganese ion.

6. The method of claim 1, wherein a diameter of the metal nanoparticle is about 1 to about 100 nanometers (nm).

7. A conductive ink composition comprising:
about 15 to about 50 parts by weight of metal nanoparticles, the metal nanoparticles being coupled to a capping polymer, having a weight-average molecular weight of about 10,000 to about 1,500,000; and
about 50 to about 80 parts by weight of a solvent.

8. The conductive ink composition of claim 7, wherein the capping polymer forms a skin layer surrounding the metal nanoparticles.

9. The conductive ink composition of claim 7, wherein a weight-average molecular weight of the capping polymer is about 40,000 to about 360,000.

10. The conductive ink composition of claim 7, wherein the capping polymer comprises polyvinyl pyrrolidone.

11. The conductive ink composition of claim 7, wherein the solvent comprises at least one selected from the group consisting of glycol, alcohol and ketone.

12. The conductive ink composition of claim 7, further comprising about 0.01 to about 5 parts by weight of a dispersion agent.

13. The conductive ink composition of claim 7, further comprising about 1 to about 20 parts by weight of a wetting agent.

14. The conductive ink composition of claim 7, wherein the metal nanoparticles comprise at least one selected from the group consisting of copper, nickel, iron, cobalt, zinc, chromium and manganese.

15. A method of forming a conductive pattern, the method comprising:
coating a conductive ink composition comprising a solvent and metal nanoparticles on a substrate, the metal nanoparticles being coupled to a capping polymer having a weight-average molecular weight of about 10,000 to about 1,500,000; and
heating the conductive ink composition to form a conductive pattern.

16. The method of claim 15, wherein a weight-average molecular weight of the capping polymer is about 40,000 to about 360,000.

17. The method of claim 15, wherein the conductive ink composition is heated at about 100 to about 400° C.

18. The method of claim 15, wherein the capping polymer comprises polyvinyl pyrrolidone.

19. The method of claim 15, wherein the conductive ink composition comprises about 15 to about 50 parts by weight of the metal nanoparticles and about 50 to about 80 parts by weight of the solvent.

20. The method of claim 15, wherein the conductive ink composition further comprises at least one of a dispersion agent and a wetting agent.

21. The method of claim 15, wherein the conductive ink composition is heated in one of the following atmospheres comprising a vacuum, in a reduction atmosphere, or in an atmosphere including an inactive gas.
